(19) United States
(12) Patent Application Publication
(10) Pub. No.: US 2010/0050491 A1
(43) Pub. Date: Mar. 4, 2010

(54) Themed picture plaque

(76) Inventor: Judy Grange, Levittown, PA (US)

Correspondence Address: THE INVENTORS NETWORK, INC., 332 ACADEMY STREET, CARNEGIE, PA, 15106, US

(21) Appl. No.: 12/231,538

(22) Filed: Sep. 4, 2008

(51) Int. Cl. A47G 1/06; B44C 5/04

(52) U.S. Cl. 40/735

(57) ABSTRACT

A themed picture holding plaque having the form of objects, flora, and fauna includes a body member having a front surface and a rear surface, a plurality of openings spaced about the body member for viewing pictures or photos disposed therein, a plurality of picture pockets mounted on the rear surface and into which the pictures are slidably disposed, a plurality of information pockets located on the rear surface with one information pocket located beneath one picture pocket for placement therein of an information sheet pertaining to the corresponding picture with each particular themed body member having either an aperture at the upper end thereof through which a fastener is inserted for wall mounting or a foldable support leg mounted on the rear surface for supporting the picture holding plaque as a free standing structure.

### FIELD OF THE INVENTION

The present invention pertains to ornamental and decorative picture holders, and more particularly pertains to a themed free standing or wall-mounted picture plaque for holding multiple pictures or photos.

### BACKGROUND OF THE INVENTION

Structures and devices to display photos, pictures, mementos, awards, degrees, certificates, and other significations of accomplishment are a common feature and complement to the décor of rooms, whether the room is a residential living room or game room, a cubicle at one's place of employment or the wall of a corporate office. Framed for mounting or hanging such photos and pictures can run the gamut from everyday scenes, vacation scenery and sights, school activities, sporting events, to personal milestones such as births, marriages, graduations, and retirements. Oftentimes the photos, pictures, mementos, etc., are also grouped around and organized by themes such as the aforementioned personal, professional, avocational, and recreational activities and accomplishments. While the majority of frames, mounts, and plaques are the traditional square or rectangular-shaped, to further personalize and enhance the visual effects for the viewers, some types of frames, mounts, and plaques may have a non-traditional shape or form.

For example, the Davis patent (U.S. Pat. No. 1,297,663) discloses a genealogical chart that can be drawn or printed on paper or any other suitable flat surface with lines and circles indicating names and lineage.

The Miller design patent (U.S. des. Pat. 143,745) discloses a design for a picture frame in the form of a freestanding tree.

The Guertin design patent (U.S. des. Pat. 276,055) discloses a freestanding design for an American family tree game panel.

The Guertin patent (U.S. Pat. No. 4,375,288) discloses an American family tree game that includes a panel having a family tree represented thereon with holders for pictures located at the end of each limb for holding a token representative of that member of the family tree.

The Gorczynski patent (U.S. Pat. No. 4,650,422) discloses a modular family tree system that includes a base, a trunk, and modular branches that snap fit to each other and to the trunk and from which dollhouses are pendant with each dollhouse capable of holding a doll that is representative of a lineage or progenitor.

The Boodram patent (U.S. Pat. No. 5,246,374) discloses an expandable family tree in the form of a kit that includes a base, a trunk, and branches with the branches including picture holders in various shapes that denote types of family relations and lineages and progenitors.

The Murray patent (U.S. Pat. No. 6,524,108 B2) discloses a three dimensional family tree consisting of a trunk, spaced branches and multiple pairs of family blocks mounted to the branches with the blocks having openings for the insertion therein of family pictures.

Nonetheless, despite the ingenuity of the above devices, there remains a need for a decorative or themed wall plaque that is either free standing or wall mounted, and allows for the removal and insertion of pictures.

### SUMMARY OF THE INVENTION

The present invention comprehends a wall-mounted or free standing picture or photograph holding plaque that is adapted to display a multitude of photos or pictures, generally organized or categorized around distinctive themes such as vacation trips, personal accomplishments or milestones, professional and career achievements, family events and gatherings, children's sports and academic accomplishments, etc. In order to enhance the display of the photographs and/or pictures, the shape or form of the plaque is not just the conventional square or rectangular-shaped frame, but is shaped for being representative of numerous themes drawn from daily life, national and religious holidays and commemorations, historical themes, sports, and the animal and natural world.

Thus, the themed picture holding plaque of the present invention includes a body member shaped or formed to represent any of the aforementioned themes, and others, with the body member having a front surface and a rear surface. Extending through the body member, and spaced about the body member, are a plurality of picture openings. Mounted to the rear surface, and in alignment with the picture openings, is a plurality of picture pockets, with one picture pocket associated with each picture opening. Each picture pocket includes an upwardly opening slot into which the picture or photo is inserted for displaying on the plaque. In addition, located immediately beneath each picture pocket is a thin, rectangular-shaped information holder that includes a side slot opening. A paper information sheet or tag containing information relevant to the corresponding photo or picture can be inserted into each respective information holder. All the information holders are also located on the rear surface immediately beneath the corresponding picture pocket.

The themed picture holding plaque can be adapted for both a wall mounted or free standing presentation. Thus, for wall mounting at least one aperture will be located at the upper end of the plaque and through which a fastener can be inserted for affixing and hanging the plaque from a wall of a room; whereas, for a free standing display of the plaque a foldable support leg can be secured to the rear surface and which is pivoted outward and away from the rear surface to support the plaque at a slight angle or tilt on a flat surface such as a desk, mantle, cabinet, or shelf.

It is an objective of the present invention to provide a themed picture holding plaque that can be manufactured from a variety of materials.

It is another objective of the present invention to provide a themed picture holding plaque in which the shape, form and design of the plaque corresponds to the type of photos, pictures, mementos, etc., being displayed thereon.

It is yet another objective of the present invention to provide a themed picture holding plaque that can be adapted for wall mounting or suspending, or can be a free standing structure.

These and other objects, features, and advantages will become apparent to those skilled in the art upon a perusal of the following detailed description when read in conjunction with the accompanying drawing figures and appended claims.

### BRIEF DESCRIPTION OF THE DRAWINGS

FIG. 1 is a perspective view of the themed picture holding plaque of the present invention illustrating the primary structural features and components of the plaque and a representative design of the plaque in the form or shape of a tree;

FIG. 2a is a perspective view of the themed picture holding plaque of the present invention first shown in FIG. 1 illustrating its mounting to one wall of a room;

FIG. 2b is a rear elevational view of the themed picture holding plaque of the present invention first shown in FIG. 1 illustrating one mounting aperture at the upper end of the picture plaque for mounting the plaque flush with the wall of the room;

FIG. 3a is a enlarged perspective view of the themed picture holding plaque of the present invention first shown in FIG. 1 illustrating one opening for holding one picture or photo from the front of the themed picture plaque;

FIG. 3b is an enlarged perspective view of the themed picture holding plaque of the present invention first shown in FIG. 1 illustrating one opening and one picture pocket from the rear of the plaque and one photo and one information sheet prior to their placement within the pocket and the information holder;

FIG. 4a is an enlarged perspective view of the themed picture holding plaque of the present invention first shown in FIG. 1 illustrating the opening for one photo located within the trunk of the themed picture plaque in the form of a tree;

FIG. 4b is an enlarged perspective view of the themed picture holding plaque of the present invention first shown in FIG. 1 illustrating the insertion of one picture into the picture pocket from the rear of the picture holding plaque;

FIG. 5 is perspective view of the themed picture holding plaque of the present invention with the plaque having the shape or form of family pet such as a dog, and the openings spaced throughout the body of the dog-shaped picture holding plaque;

FIG. 6 is a rear elevational view of the themed picture holding plaque of the present invention having the shape or form of the family pet first shown in FIG. 5 illustrating structure to support the picture plaque as a free standing structure;

FIG. 7 is a front elevational view of the themed picture holding plaque of the present invention with the plaque having the shape or form of a baseball and picture pockets spaced about the baseball-shaped plaque.

### DETAILED DESCRIPTION OF THE PREFERRED EMBODIMENT

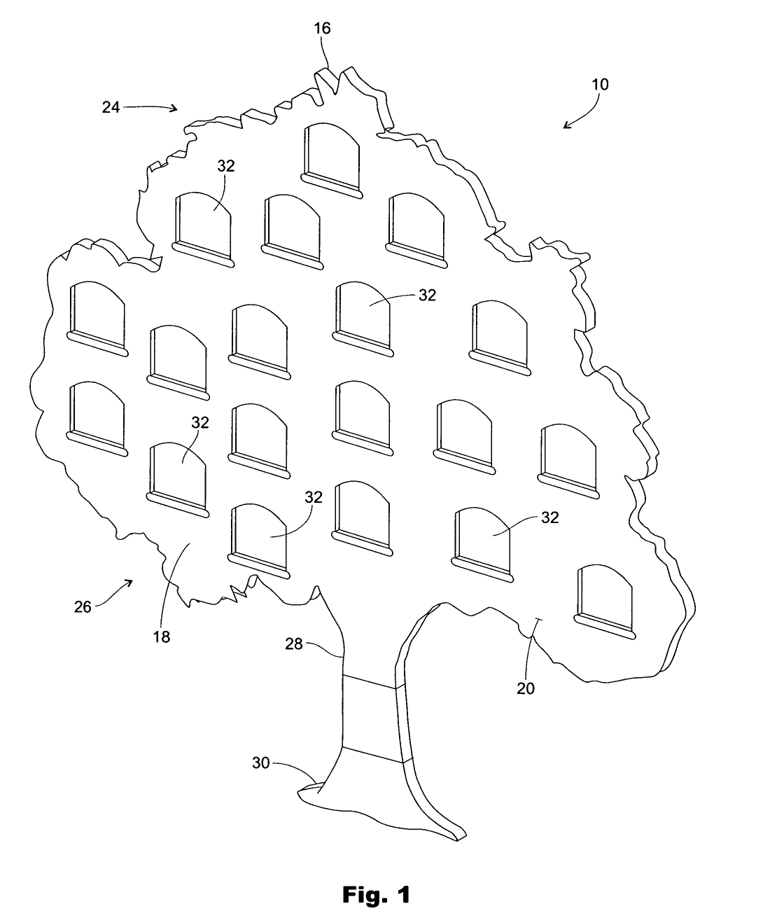

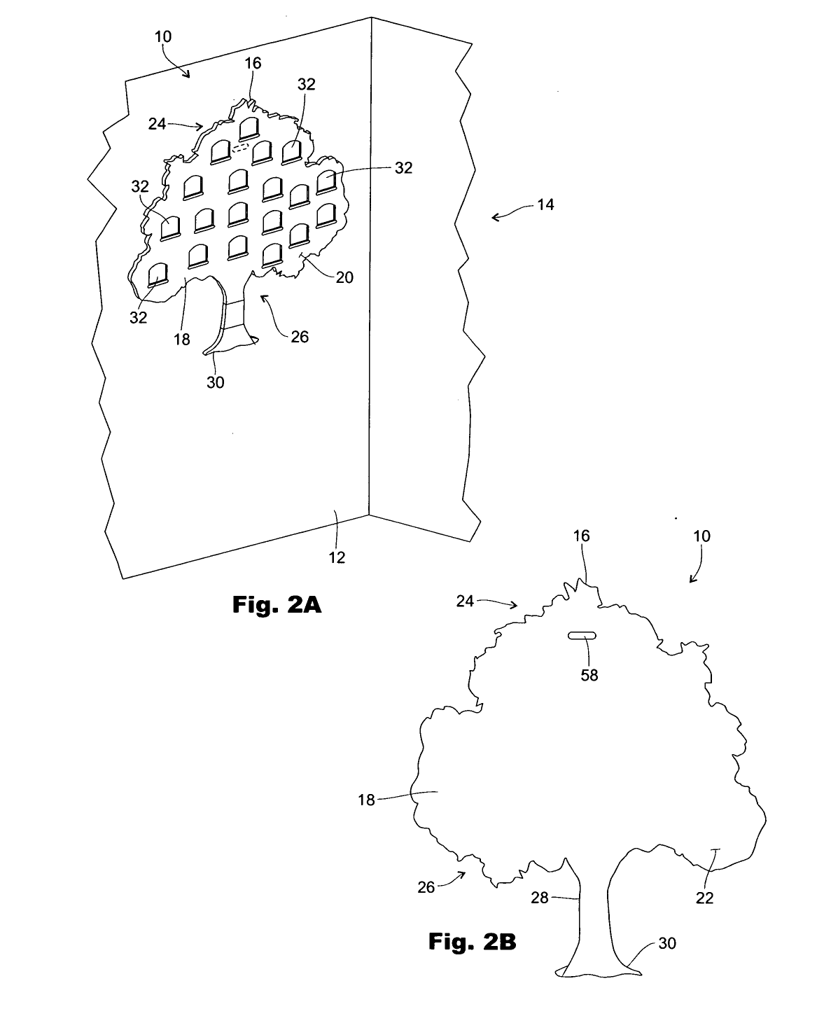

Illustrated in FIGS. 1-7 is a themed picture or photo holding plaque 10 that includes mounting means for affixing and supporting the plaque 10 from a wall 12 of a room 14, as shown in FIG. 2a, or mounting means for supporting the plaque 10 on a flat surface, such as a table, desk, mantle, or cabinet, as a free standing structure as shown in FIG. 6. The picture holding plaque 10 is themed in that the shape or form of the plaque 10 can be varied to correspond to the type of photos or pictures being displayed, or the plaque 10 can have the shape or form representative of seasons of the year, holiday events and occasions, sport and recreational activities, national holidays, events, and commemorations, natural flora and fauna, etc. This allows the individual to personalize their photo or picture display.

Thus, illustrated in FIGS. 1-4b is the representative themed picture holding plaque 10 in the form of a tree 16. It should be noted that certain basic structural elements and features are included in all picture holding plaques 10 irrespective of their particular shape or form for representing a given theme. Therefore, the ornamental and decorative picture holding plaque 10 of FIGS. 1-4b includes a body member 18 with the body member 18 having a front surface 20 that defines the front of the plaque 10 and a rear surface 22 that defines the rear of the plaque 10. In addition, the body member 18 includes an upper end 24 and a lower end 26. In addition, a trunk 28 and a base 30 are included for the plaque 10 shaped as a tree as shown in FIGS. 1-4b.

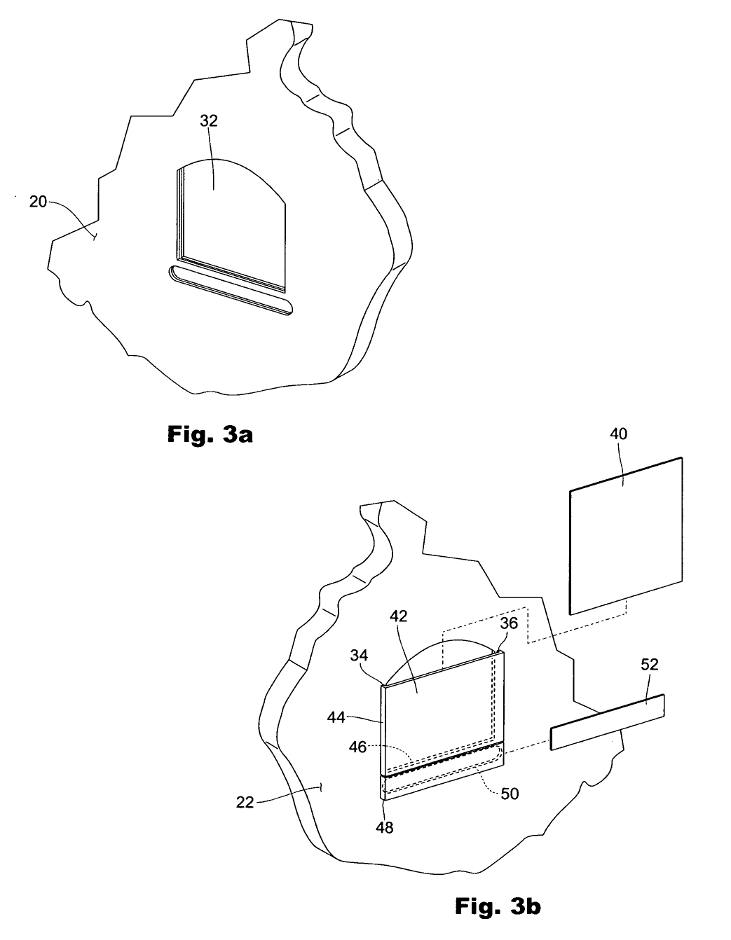

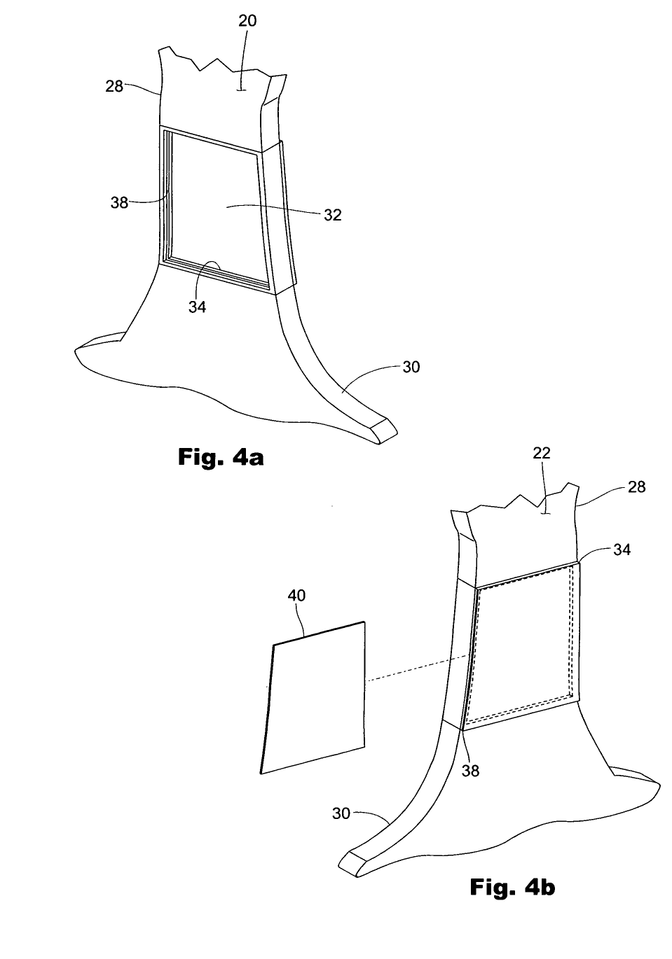

As shown in FIGS. 1-4b, and also 5-7, the picture holding plaque(s) 10 includes a plurality of picture or photo openings 32 spaced about the body member 18 and extending through the body member 18. The picture openings 32 are generally sized to display standard 4 by 6 inch photos or pictures or 5 by 7 inch photos or pictures; however, the openings 32 can vary in size to display the range of picture dimensions. Mounted to the rear surface 22 of the body member 18 is a plurality of photo or picture holders or pockets 34, and, more specifically, there is one picture pocket 34 associated with and corresponding to each picture opening 32. As shown in FIGS. 3b, 4b, and 6, the picture pockets 34 are generally rectangular-shaped, and include either an upwardly opening slot 36 or a side slot 38 through which the photo or picture 40 is inserted for display and from which the picture 40 can be removed therefrom when the individual desires to change the picture display. Thus, the picture pocket 34 of FIGS. 3a and 3b includes the upwardly opening slot 36 while the picture pocket 34 shown in FIGS. 4a and 4b includes the side opening slot 38. The picture pockets 34 also include a flat back portion 42 adjoined along its vertical sides to a pair of opposed side portions 44 and a horizontally extending bottom portion 46 upon which the lower edge of the picture or photo 40 actually rests.

Each picture pocket or holder 34 also includes a generally rectangular-shaped information pocket or holder 48 adjoined to, and located immediately beneath, the respective picture pocket 34. The information holder 48 can be integrally joined and formed to the respective picture pocket 34. Each information holder 48 includes a side aperture 50 into which a slender information tag or sheet 52 is removably insertable. The information sheet 52 will include brief information about the above positioned photo or picture 40, and can be removed for updating or revising as needed.

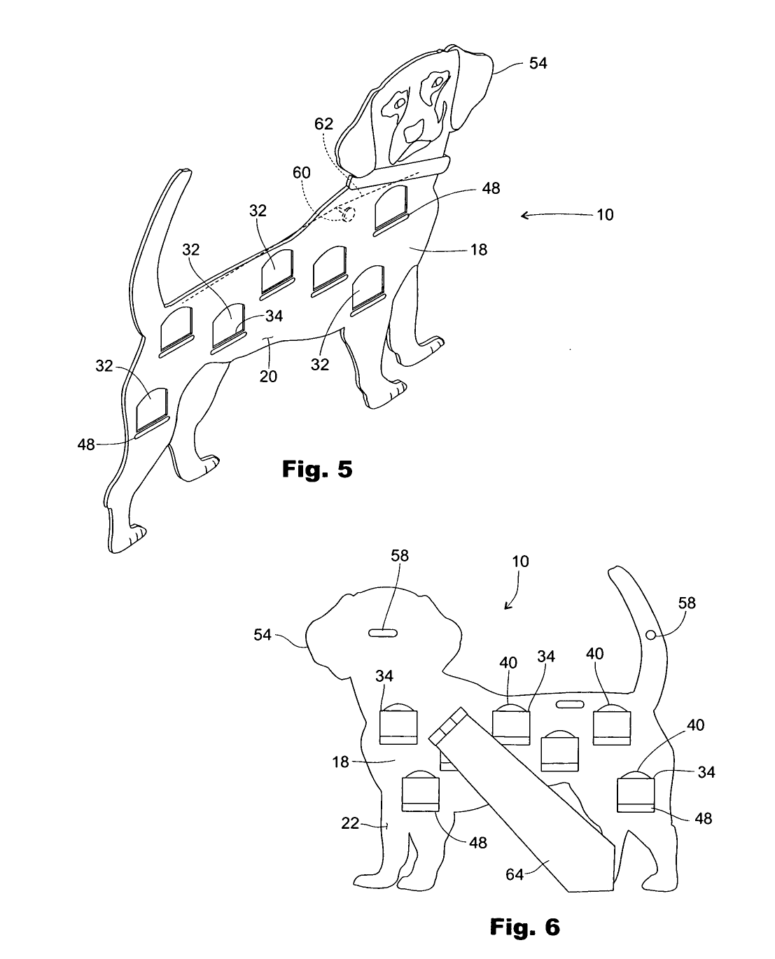

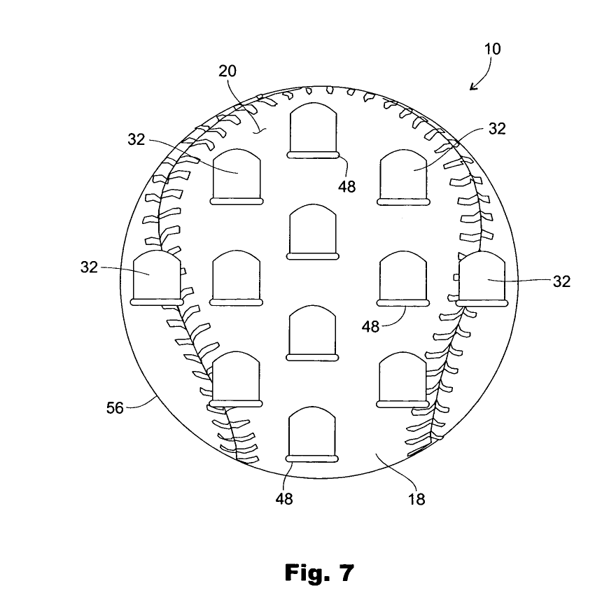

The picture holding plaque 10 can be shaped or formed to represent almost any theme conceivable, and in addition to the tree-shaped plaque 10 of FIGS. 1-4b, a plaque having the shape of a family pet 54, i.e. a dog, is shown in FIGS. 5 and 6 for displaying family pet photos, the plaque 10 shown in FIG. 7 has the shape or form of a baseball 56 for displaying photos and pictures of youth athletics and sport activities and accomplishments. Additional themed plaques may represent the following themes: The celebrity tree; The music tree; The food tree (for use in grocery stores); The beverage tree (for use in lounges and bars); The alumni tree; The pet tree; The car tree (for car dealers, collectors, hot rods, etc.); The sports tree (the plaque would have the shape of a football, soccer ball, bowling ball, etc.); The student tree (for use in classrooms); and The president tree (for use in educational settings). Moreover, specialty plaques can be custom ordered and manufactured as desired.

Mounting means for mounting the plaque(s) 10 to the wall 12 or upon a flat surface are shown in FIGS. 2a, 2b, 5 and 6. Specifically, the wall mounting means includes at least one aperture 58 extending through the body member 18 adjacent the upper end 24 and through which a fastener 60 is inserted for fixing the fastener 60 into the wall 12 for suspending the plaque 10 therefrom. In addition, the fastener 60 can support a cord or string 62 for suspending and hanging the plaque 10 from the wall 12. FIG. 6 illustrates the mounting means for supporting the plaque 10 on a flat surface, and the mounting means for flat surface supporting includes at least one support leg 64 pivotally and foldably attached to the rear surface 22 of the body member 18. In order to set up and display the photos 40 that have been inserted into the picture pockets 34, the support leg 64 would be pivoted outward for placement upon the flat surface thereby supporting the plaque 10 at a slight tilt or angle thereupon.

The foregoing description of the preferred embodiments of the invention have been presented for the purposes of illustration and description; and many modifications, alterations, variations, and changes are possible, practicable, and conceivable to those skilled in the art without departing from the scope and spirit of the invention; therefore, the invention is not to be limited to the embodiments and examples shown, described, illustrated, and elucidated thereupon, but by such limitations as set forth in the appended claims broadly construed and interpreted.

I claim:

1. A themed picture holding plaque for holding and displaying pictures, comprising:
a body member having a front surface and a rear surface;
a plurality of picture openings spaced about the body member;
a plurality of picture pockets mounted to the rear surface with one picture pocket aligned with and corresponding to one picture opening;
each picture pocket including a back portion, a pair of opposed side portions adjoined to the back portion, and a bottom portion joined to the back portion and the side portion for holding and displaying therein at least one picture;
a plurality of information holders with each information holder adjoined to each respective picture pocket and located immediately beneath the respective picture pocket;
each information holder including an upwardly opening slot for receiving and displaying therein an information sheet containing information pertaining to the respective picture displayed in the adjoined picture pocket;
the body member having a shape representative of the theme of the pictures that are displayed in the picture pockets; and
mounting means for mounting the plaque to the wall of the room in which the pictures are being displayed.

2. The themed picture holding plaque of claim 1 further comprising a support leg pivotally attached to the rear surface of the body member for supporting the plaque in a substantially upright position on a flat surface.

3. The themed picture holding plaque of claim 2 wherein the picture pocket includes a side opening slot through which the picture is inserted for display within the picture pocket.

4. The themed picture holding plaque of claim 3 wherein the body member includes and upper end and an opposite lower end.

5. The themed picture holding plaque of claim 4 wherein at least one aperture is located adjacent the upper end and through which a fastener is inserted for hanging the plaque from the wall of the room in which the pictures are to be displayed.
